(19) United States
(12) Patent Application Publication
(10) Pub. No.: US 2010/0039745 A1
(43) Pub. Date: Feb. 18, 2010

(54) METHOD OF ANTISTATIC DEPOSITION ON COMPONENTS OF MOBILE PHONE

(76) Inventors: Byung Hoon Ryou, Seoul (KR); Won Mo Sung, Gyeonggi-do (KR); Jun Lee, Gyeonggi-do (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/440,018

(22) PCT Filed: Aug. 31, 2007
(86) PCT No.: PCT/KR2007/004197

§ 371 Date: Sep. 29, 2009

(30) Foreign Application Priority Data
Sep. 1, 2006 (KR) 10-2006-0083994

(51) Int. Cl. H05F 1/02; B05D 7/00; B29C 43/18

(52) U.S. Cl. 361/220; 427/123; 427/126.1; 427/126.4; 264/104

(57) ABSTRACT

The present invention provides an antistatic deposition method of a wireless terminal component, which comprises depositing tin (Sn) or a tin-aluminum (Sn—Al) alloy on a molded material for a wireless terminal component. Also, the present invention discloses an antistatic deposition method of a wireless terminal component, which comprises: depositing tin (Sn) or a tin-aluminum (Sn—Al) alloy on a molded material for a wireless terminal component; and depositing one or more materials selected from the group consisting of Si, SiO, Ti, TiO, Al O and a mixture thereof on the deposited tin (Sn) layer or the deposited tin-aluminum (Sn—Al) alloy layer. The antistatic deposition method of a wireless terminal component according to the present invention has advantageous effects in that it overcomes the problems of the prior art that generation of static electricity adversely affects the performance of the inner circuits of the wireless terminal in case where a metal such as nickel (Ni), chrome (Cr) or the like is deposited on a wireless terminal component so as to create a mirror effect, and in that it can maintain an mirror effect and the performance of radio frequencies, can prevent peel-off of a tin (Sn) or tin-aluminum (Sn—Al) alloy deposited on a molded material for a wireless terminal component, and can improve scratch resistance and impact resistance of the wireless terminal component.

### TECHNICAL FIELD

The present invention relates to an antistatic deposition method of a wireless terminal component such as a display protective widow, a navigation key, a side key, a case or the like. More particularly, the present invention relates to an antistatic deposition method of a wireless terminal component, which comprises depositing tin (Sn) or a tin-aluminum (Sn—Al) alloy on a molded material for a wireless terminal component. Also, the present invention relates to an antistatic deposition method of a wireless terminal component, which comprises: depositing tin (Sn) or a tin-aluminum (Sn—Al) alloy on a molded material for a wireless terminal component; and depositing one or more materials selected from the group consisting of Si, SiO₂, Ti, TiO₂, Al₂O₃ and a mixture thereof on the deposited tin (Sn) layer or the deposited tin-aluminum (Sn—Al) alloy layer. In addition, the present invention relates to a wireless terminal component (particularly, display protective windows) on which a tin (Sn) or tin-aluminum (Sn—Al) alloy layer is deposited, or the tin (Sn) or tin-aluminum (Sn—Al) alloy layer and a layer made of one or more materials selected from the group consisting of Si, SiO₂, Ti, TiO₂, Al₂O₃ and a mixture thereof are sequentially deposited.

### BACKGROUND ART

Conventionally, a metal such as nickel (Ni), chrome (Cr) or the like is deposited on a wireless terminal component so as to create a mirror effect. In this case, a metal having electrical conductivity generates static electricity to thereby adversely affect the performance of the inner circuits of the wireless terminal. Especially, in case of using high frequencies, such a problem occurs more remarkably. In addition, a wireless terminal component plated with nickel (Ni), chrome (Cr) or the like entails a problem in that it reduces the radiation performance of radio waves.

### DISCLOSURE OF INVENTION

### Technical Problem

Accordingly, an object of the present invention has been made to overcome the above-mentioned problems occurring in the prior art, and it is an object of the present invention to provide an antistatic deposition method of a wireless terminal component, which can maintain an mirror effect and the performance of radio frequencies, can prevent peel-off of a tin (Sn) or tin-aluminum (Sn—Al) alloy deposited on a molded material for a wireless terminal component, and can improve scratch resistance and impact resistance of the wireless terminal component.

Another object of the present invention is to provide an antistatic deposition method of a wireless terminal component, which can easily form patterns on even a wireless terminal component made of a material which is not allowed to be plated or deposited, can increase a degree of freedom of design, and can manufacture the wireless terminal component in a three-dimensional shape with a diversified upscale design and color.

### Technical Solution

To accomplish the above object, the present invention provides an antistatic deposition method of a wireless terminal component such as a display protective widow, a navigation key, a side key, a case or the like, and other information communication equipment components. More particularly, the present invention provides an antistatic deposition method of a wireless terminal component, which comprises depositing tin (Sn) or tin-aluminum (Sn—Al) alloy on a molded material for a wireless terminal component. The present invention employs tin (Sn) or tin-aluminum (Sn—Al) alloy with a very low electrical conductivity in its deposition on a molded material for a wireless terminal component to thereby prevent a deterioration in the performance of the inner circuits of the wireless terminal due to generation of static electricity while maintaining a mirror effect. A molded material for the wireless terminal component, on which tin (Sn) or tin-aluminum (Sn—Al) alloy is deposited, is preferably a molded material for a wireless terminal component, which is molded by a dual-injection molding process using an acrylonitrile butadiene styrene (ABS) resin which is allowed to be plated and a polycarbonate (PC) resin which is not allowed to be plated or is difficult to plate.

### Advantageous Effects

As described above, an antistatic deposition method of a wireless terminal component according to the present invention has an advantageous effect in that it overcome the problems of the prior art, and in that it can maintain an mirror effect and the performance of radio frequencies, can prevent peel-off of a tin (Sn) or tin-aluminum (Sn—Al) alloy deposited on a molded material for a wireless terminal component, and can improve scratch resistance and impact resistance of the wireless terminal component.

A transcription inmold method or an insert in-mold method according to the present invention has an advantageous effect in that it can easily form patterns on even a wireless terminal component made of a material which is not allowed to be plated, can increase a degree of freedom of design, and can manufacture the wireless terminal component in a three-dimensional shape with a diversified upscale design and color.

### BRIEF DESCRIPTION OF THE DRAWINGS

FIG. 1 is a cross-sectional view illustrating a state where a tin (Sn) layer or a tin-aluminum aluminum (Sn—Al) alloy layer is deposited on a molded material for a wireless terminal component; and

FIG. 2 is a cross-sectional view illustrating a state where a tin (Sn) or tin-aluminum (Sn—Al) alloy layer and a layer made of one or more materials selected from the group consisting of Si, SiO₂, Ti, TiO₂, Al₂O₃ and a mixture thereof is sequentially deposited on a molded material for a wireless terminal component.

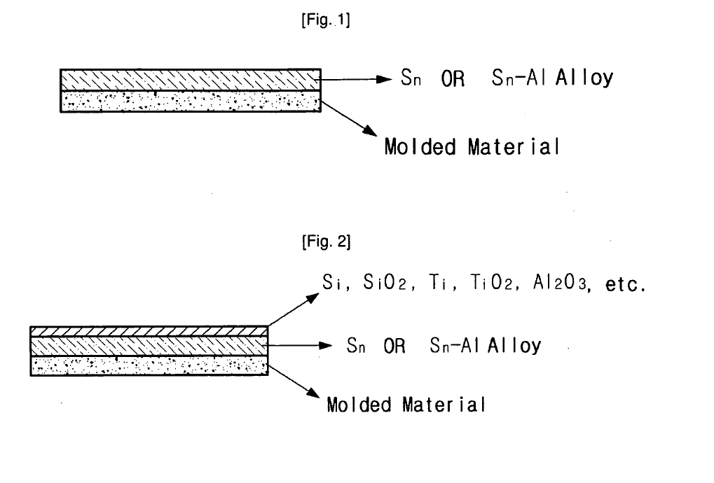

### BEST MODE FOR CARRYING OUT THE INVENTION

Reference will now be made in detail to a preferred embodiment of the present invention with reference to the attached drawings.

According to one embodiment of the present invention, there is provided an antistatic deposition method of a wireless terminal component such as a display protective widow, a navigation key, a side key, a case or the like, and other information communication equipment components. More particularly, according to the embodiment of the present invention, there is provided an antistatic deposition method of a wireless terminal component, which comprises depositing tin (Sn) or a tin-aluminum (Sn—Al) alloy on a molded material for a wireless terminal component. In the embodiment of the present invention, tin (Sn) or a tin-aluminum (Sn—Al) alloy with a very low electrical conductivity is employed in its deposition on a molded material for a wireless terminal component to thereby prevent a deterioration in the performance of the inner circuits of the wireless terminal due to generation of static electricity while maintaining a mirror effect.

A molded material for the wireless terminal component, on which tin (Sn) or a tin-aluminum (Sn—Al) alloy is deposited, is preferably a molded material for a wireless terminal component, which is molded by, but not limited to, a dual-injection molding process using an acrylonitrile butadiene styrene (ABS) resin which is allowed to be plated and a polycarbonate (PC) resin which is not allowed to be plated or is difficult to plate.

According to another embodiment of the present invention, there is provided an antistatic deposition method of a wireless terminal component, which comprises:

depositing tin (Sn) or a tin-aluminum (Sn—Al) alloy on a molded material for a wireless terminal component; and depositing one or more materials selected from the group consisting of Si, SiO₂, Ti, TiO₂, Al₂O₃ and a mixture thereof on the deposited tin (Sn) layer or the deposited tin-aluminum (Sn—Al) alloy layer. The layer made of one or more materials selected from the group consisting of Si, SiO₂, Ti, TiO₂, Al₂O₃ and a mixture thereof is deposited on the tin (Sn) layer or the tin-aluminum (Sn—Al) alloy layer, thereby preventing peel-off of the tin (Sn) or tin-aluminum (Sn—Al) alloy deposited on a molded material for a wireless terminal component and increasing hardness of the deposited surface to improve scratch resistance and impact resistance of the wireless terminal component.

A weight ratio of tin to aluminum of the tin-aluminum (Sn—Al) alloy used in the antistatic deposition method of a wireless terminal component is 85% by weight:15% by weight to 95% by weight:5% by weight, preferably 90% by weight:10% by weight. The tin-aluminum (Sn—Al) alloy may be electrically plated. In this case, the electrically plated tin-aluminum (Sn—Al) alloy forms a solid solution and exhibits physical properties of relatively low melting point, excellent electrical and thermal conductivity and excellent flexibility.

In the antistatic deposition method of a wireless terminal component according to the embodiment of the present invention, a layer made of one or more materials selected from the group consisting of Si, SiO₂, Ti, TiO₂, Al₂O₃ and a mixture thereof deposited on the tin(Sn) layer or the tin-aluminum (Sn—Al) alloy layer is preferably about 0.5-20□ in thickness.

According to another embodiment of the present invention, there is also provided a wireless terminal component on which a tin (Sn) or tin-aluminum (Sn—Al) alloy layer is deposited, or the tin (Sn) or tin-aluminum (Sn—Al) alloy layer and a layer made of one or more materials selected from the group consisting of Si, SiO₂, Ti, TiO₂, Al₂O₃ and a mixture thereof are sequentially deposited. Particularly, in the inventive embodiment, there is also provided a display protective window which has a tin (Sn) or tin-aluminum (Sn—Al) alloy layer deposited on a rear surface thereof, or has the tin (Sn) or tin-aluminum (Sn—Al) alloy layer and a layer made of one or more materials selected from the group consisting of Si, SiO₂, Ti, TiO₂, Al₂O₃ and a mixture thereof are sequentially deposited on a rear surface thereof.

The wireless terminal component, on which the tin (Sn) or the tin-aluminum (Sn—Al) alloy is deposited, exhibits an excellent mirror effect as well as no deterioration in the performance of the inner circuits of the wireless terminal due to generation of static electricity.

Moreover, there is provided a transcription inmold method or an insert inmold method of the wireless terminal component according to another embodiment of the present invention which employs a polyethylene terephthalate (PET) film, etc., plated with tin (Sn) or a tin-aluminum (Sn—Al) alloy.

The transcription inmold method refers to a technique in which a film printed with a predetermined pattern is put into a mold to perform injection so that a pattern is transcribed on a molded material. The insert inmold method refers to a technique in which a film printed with a predetermined pattern is put into a mold to perform injection so that the film is formed integrally with a molded material to thereby form the pattern on the molded material.

According to this embodiment, after tin (Sn) or a tin-aluminum (Sn—Al) alloy has been deposited on a polyethylene terephthalate (PET) film, etc., without directly depositing tin (Sn) or a tin-aluminum (Sn—Al) alloy on a molded material for a wireless terminal component, the deposited polyethylene terephthalate (PET) film is used to perform the transcription inmold method or the insert inmold method on the molded material for a wireless terminal component. Thus, it is possible to easily form patterns on even a wireless terminal component made of a material which is not allowed to be plated or deposited and increase a degree of freedom of design. Further, the use of the polyethylene terephthalate (PET) film can prevent a deformation of the molded material for the wireless terminal component or deposited layers, and can manufacture a product with diverse colors.

While the invention has been described in connection with what is presently considered to be practical exemplary embodiments, it is to be understood that the invention is merely exemplary and not limited to the disclosed embodiments. Therefore, a person skilled in the art can perform various changes and modifications based on a principle of the present invention, which falls in the scope of the present invention. The scope of the present invention should be defined by the claims and their equivalents, but not the embodiments as described above.

1. An antistatic deposition method of a wireless terminal component, comprising depositing tin (Sn) on a molded material for a wireless terminal component.

2. An antistatic deposition method of a wireless terminal component, comprising depositing a tin-aluminum (Sn—Al) alloy on a molded material for a wireless terminal component.

3. The antistatic deposition method as defined in claim 1, further comprising depositing one or more materials selected from the group consisting of Si, SiO₂, Ti, TiO₂, Al₂O₃ and a mixture thereof.

4. The antistatic deposition method as defined in claim 1, wherein the wireless terminal component is a display protective widow, a navigation key, a side key, or a case.

5. The antistatic deposition method as defined in claim 1, wherein the molded material for the wireless terminal component is molded by a dual-injection molding process using an acrylonitrile butadiene styrene (ABS) resin which is allowed to be plated and a polycarbonate (PC) resin which is not allowed to be plated or is difficult to plate.

6. The antistatic deposition method as defined in claim 2, wherein a weight ratio of tin to aluminum of the tin-aluminum (Sn—Al) alloy is 85% by weight: 15% by weight to 95% by weight: 5% by weight.

7. The antistatic deposition method as defined in claim 6, wherein a weight ratio of tin to aluminum of the tin-aluminum (Sn—Al) alloy is 90% by weight: 10% by weight.

8. A transcription inmold or insert inmold method of a wireless terminal component, employing a film on which tin (Sn) or a tin-aluminum (Sn—Al) alloy is deposited.

9. A wireless terminal component deposited with a tin (Sn) or tin-aluminum (Sn—Al) alloy.

10. The wireless terminal component as defined in claim 9, wherein a layer made of one or more materials selected from the group consisting of Si, SiO₂, Ti, TiO₂, Al₂O₃ and a mixture thereof is deposited on the tin (Sn) or tin-aluminum (Sn—Al) alloy.
